(19) United States
(12) Patent Application Publication
(10) Pub. No.: US 2005/0194721 A1
(43) Pub. Date: Sep. 8, 2005

(54) Polycarbonate molded parts having low dust attraction

(76) Inventors: Peter Bier, Krefeld (DE); Peter Capellen, Krefeld (DE)

Correspondence Address: BAYER MATERIAL SCIENCE LLC, 100 BAYER ROAD, PITTSBURGH, PA, 15205, US

(21) Appl. No.: 10/858,677

(22) Filed: Jun. 2, 2004

(30) Foreign Application Priority Data
Jun. 5, 2003 (DE) 10325437.4

(51) Int. Cl. B29C 71/00

(52) U.S. Cl. 264/446; 264/448; 264/80

(57) ABSTRACT

A process for the production of polycarbonate molded article having low dust attraction is disclosed. the process entails treating at least a portion of the surface of a molded article by at least one procedure selected from the group consisting of flame treatment, corona treatment and plasma treatment to obtain a treated surface.

### FIELD OF THE INVENTION

The application concerns thermoplastic molding and in particular a process for molding polycarbonate moldarticles.

### SUMMARY OF THE INVENTION

A process for the production of polycarbonate molded article having low dust attraction is disclosed. the process entails treating at least a portion of the surface of a molded article by at least one procedure selected from the group consisting of flame treatment, corona treatment and plasma treatment to obtain a treated surface.

### BACKGROUND OF THE INVENTION

In plastic molded parts the accumulation of dust with formation of dust figures is a widespread problem. See for example in this connection Saechtling, Kunststoff-Taschenbuch, 26^{th} edition, Hanser Verlag, 1995, Munich, p. 140 ff. Dust deposits on transparent molded parts are particularly troublesome and restrictive to function. Such molded parts are used for example for the area of optical data carriers, electrical engineering, automotive construction, in the building sector, for liquid containers or for other optical applications. For all these applications dust accumulation is undesirable and can have a detrimental effect on function.

A known method of reducing dust accumulation on plastic parts is the use of antistatics. In the literature, antistatics that restrict dust accumulation are described for thermoplastics (see e.g. Gächter, Müller, Plastic Additives, Hanser Verlag, Munich, 1996, p. 749 ff.). These antistatics improve the electrical conductivity of the plastic molding compositions and so divert the surface charges that form during manufacture and use. Dust particles are thus less attracted and consequently there is less dust accumulation.

With antistatics a distinction is generally made between internal and external antistatics. An external antistatic is applied to the plastic molded parts after processing, an internal antistatic is added to the plastic molding compositions as an additive. For economic reasons the use of internal antistatics is mostly desirable as no further steps to apply the antistatic after processing are needed. Until now few internal antistatics that also form fully transparent molded parts, especially with polycarbonate, have been described in the literature.

JP-A 06-228420 describes aliphatic sulfonic acid aluminium salts in polycarbonate as an antistatic. These compounds lead to a reduction in molecular weight, however. JP-A 62-230835 describes the addition of 4% nonyl phenyl sulfonic acid tetrabutyl phosphonium in polycarbonate.

A disadvantage of the known internal antistatics is that they have to be used in relatively high concentrations in order to achieve the antistatic effect. However, this alters the material properties of the plastics in undesirable ways.

External antistatics have the disadvantage that they frequently become yellow under the action of heat and intensive incident light radiation. Furthermore, they are easily removed by external influences such as rubbing, development of water films, etc.

The object of the invention was therefore to provide a process for the production of polycarbonate molded parts with low dust attraction wherein the material properties of the plastic should not be negatively influenced.

### DETAILED DESCRIPTION OF THE INVENTION

Surprisingly it was found that this object is achieved by a process which by surface treatment of the polycarbonate molded parts by flame treatment, corona treatment and/or plasma activation changes the surface characteristics of the material such that dust attraction no longer occurs, without changing the material properties of the molded part.

The invention thus provides a process for the production of polycarbonate molded parts with low dust attraction, characterised in that it comprises a surface treatment of the polycarbonate molded parts by flame treatment, corona treatment and/or plasma activation.

The surface treatment presumably increases the surface tension and in particular dramatically increases the polar portion of the surface tension. Particularly good results are obtained if the polar portion of the surface tension is greater than 20%.

The surface tension and the polar content may be determined by known methods, which are described inter alia in the following literature: “Einige Aspekte der Benetzungstheorie und ihre Anwendungen auf die Untersuchung der Veränderung der Oberflächeneigenschaften von Polymeren” in Farbe und Lack, volume 77, no. 10, 1971, p. 997 ff.; “Determination of contact angles and solid surface tensions of poly(4-X-styrene) films” in Acta Polym. 1998, 49, p. 417-426; “Wettability and microstructure of polymer surfaces: stereochemical and conformational aspects” in Apparent and Microscopic Contact Angles, pp. 111-128.

According to a first embodiment of the invention the surface treatment is carried out by flame treatment.

In flame treatment an open flame, preferably its oxidizing part, acts upon the surface of the plastic molded part. An exposure time of around 0.2 s is generally sufficient, depending on the shape and weight of the molded part to be activated.

Experience shows that adjusting the flammable mixture so that the air content is slightly above the stoichiometric amount (slightly lean mixture) generally produces the best results. The oxygen drawn in from outside during the combustion process as well as all the oxygen contained in the air-gas mixture supplied contribute to the oxidizing effect of the flame.

The air-gas mixture supplied also has a strong influence on the characteristics of the flame, so a flame operated with a “rich” mixture (high gas content) is just as unstable as one operated with a “lean” mixture (low gas content).

Standard values for the mixture adjustment are the following air/gas ratios:

| | |
|---|---|
| Air to methane (natural gas) | ≧8:1 |
| Air to propane (LPG) | ≧25:1 |
| Air to butane | ≧32:1 |

In addition to the mixture adjustment, the burner setting and burner distance are also critical for an effective flame treatment. The burner output influences all the flame characteristics (temperature, ion distribution, active zone size). Changing the burner output changes the flame length and in turn effects the distance from the burner to the product.

The burner output, generally expressed in kW, is directly proportional to the volume of gas flow at any one time (liters per minute). Too low an output leads to a reduced treatment, i.e. the surface energy is not increased sufficiently. A higher output also establishes a higher ion concentration, and the treatment is made more intensive. Too high an output leads to a high material temperature and hence to incipient melting of the surface. This can be detected where the surface becomes glossy or matt after flame treatment.

The operating speed and hence the contact time is generally defined by the user, and this determines the required burner output. The operating speed and the burner output should be adjusted to give the best result.

It has proven to be particularly advantageous if the flame treatment is performed in a continuous flame treatment plant at a throughput rate of 1 to 20 m/min, in particular 2 to 10 m/min.

According to a second embodiment of the invention the surface treatment is performed by corona treatment.

In conventional (direct) corona systems, the part to be treated is introduced directly into the discharge gap of a corona discharge. In the treatment of films the gap is formed by the roll, which guides the web, and the electrode, which is approximately 1.5 to 2.0 mm above the roll. If the electrode is further away, a raised electrical voltage has to be applied to ignite the discharge, such that the energy content of the individual discharge increases and increasingly hot arc discharges may form, which should be avoided for a proper treatment of the substrate.

Typical power densities for these conventional electrodes are around 1 W/mm for a single electrode rod.

In indirect corona systems the electrical discharge occurs ahead of the workpiece. An air stream directs the discharge sparks onto the workpiece to be treated, such that only indirect contact occurs with the discharge. One principle of indirect corona treatment involves allowing the discharge to burn between two metal pin electrodes. The current limitation that is needed to form a corona discharge occurs electronically. The discharge sparks are deflected with air. Treatment distances ranging from 5 to 20 mm are achieved here. Due to this large discharge distance it is vital to minimize the energy content of the individual discharges using design measures.

By means of high operating frequencies of around 50 kHz and optimized discharge geometry and air control, the discharge intensity may be reduced to 100 W. A suitable system is e.g. the CKG corona gun from Tigris. Single electrodes with an effective width of around 20 mm may be used here.

Even polycarbonate molded parts with complicated geometries may be treated by combining multiple electrodes. The arrangement may be adjusted to three-dimensional parts.

Pretreatment takes place with cold corona discharges so that no. substantial heating of the molded part occurs. The surfaces of heat-sensitive plastics thus undergo no optical changes, and damage such as streaking and clouding does not occur.

Various corona techniques are available for the pretreatment of three-dimensional products, such as low-frequency (LF) systems, high-frequency (HF) systems and spot generators, which may be used according to the individual product.

Spot generators produce a high-voltage discharge, which is pressed onto the substrate by air, without the use of a counterelectrode. A spot generator may easily be integrated into existing production lines, is easy to use and generally includes timer and alarm functions. The pretreatment width is 45 to 65 mm, allowing a wide variety of products to be pretreated. The spot generator may also be supplied with two or more discharge heads.

In high-frequency corona a high-voltage discharge with a frequency of 20 to 30 kHz is generated, which forms a corona field between two electrodes in air. This corona activates the surface and so produces greater adhesion and wettability. Corona activation of sheets and simple 3D geometries is possible at high speeds.

A corona tunnel (e.g. Tantec), with which the entire surface of a body may be pretreated in the production line, is suitable for the pretreatment of complex molded parts. The special design of the electrodes means that an absolutely homogeneous surface energy is achieved. Vertical side walls and 90° angles may also be treated. The corona tunnel design is generally product-specific and may also be integrated into existing plants. It allows for example a non-contact pretreatment of the entire top side of parts measuring up to 100 mm high and 2000 mm wide.

The corona treatment is preferably performed in a continuous corona plant at a throughput rate of 1 to 20 m/min, in particular 2 to 10 m/min, and/or at an output of 500 to 4000 W, in particular 1500 to 3500 W.

According to a third embodiment of the invention the surface treatment is performed by plasma activation. The plasma activation is preferably performed in a chamber under a pressure of 1 to 10⁻² mbar, in particular 10⁻¹ to 10⁻² mbar, and at an output of 200 to 4000 W, in particular 1500 to 3500 W, with a low-frequency generator and in the presence of a process gas, such as e.g. oxygen or in particular air, (e.g. BPA 2000 Standard System from Balzers).

In a further embodiment of the invention it has additionally proven particularly effective to apply metal oxide layers to the substrate for flame treatment in the same operation in order to render the substrate surfaces free from dust attraction. Particularly suitable is an addition of aluminium, tin, indium, silicon, titanium, zirconium and/or cerium compounds to the combustion gas/air mixture. Metering of the additives to produce the non-dust-attracting topcoat operates on the principle of a metered admixture of an organic precursor or an aerosol in the air stream. Metering is performed by process-controlled evaporation or a spray mist. Suitable devices are for example the SMB22 burner in combination with control devices from the FTS range produced by arcogas GmbH, Rotweg 24, Mönsheim, Germany. Volatile organometallic compounds, in particular alkoxides or acetates of the above metals, are suitable as organic precursors. Silicon tetraalkoxides have proven especially favorable.

Aqueous dispersions of metal oxide nanoparticles, which are injected into the air stream and deposited onto the surface via the flame, are most suitable for the production of aerosols.

In comparison to the plasma process described in U.S. Pat. No. 5,008,148, the application of the metal oxide layers in accordance with the present invention is substantially simpler and more cost-effective.

U.S. Pat. No. 5,008,148 describes the coating of polycarbonate or polyphenylene sulfide articles with metal oxide layers by means of a low-pressure plasma process for UV protection. The articles thus produced are not free from dust attraction.

Transparent thermoplastics are preferably used as the transparent plastic, particularly preferably the polymers of ethylene-unsaturated monomers and/or polycondensates of bifunctional reactive compounds.

Particularly suitable plastics are polycarbonates or copolycarbonates based on diphenols, polyacrylates or copolyacrylates and polymethacrylates or copolymethacrylates such as e.g. polymethyl or copolymethyl methacrylate, also as copolymers with styrene such as e.g. transparent polystyrene acrylonitrile (SAN), also transparent cycloolefins, polycondensates or copolycondensates of terephthalic acid, such as e.g. polyethylene or copolyethylene terephthalate (PET or CoPET) or glycol-modified PET (PETG).

The person skilled in the art may obtain excellent results with polycarbonates or copolycarbonates.

Thermoplastic, aromatic polycarbonates within the meaning of the present invention are both homopolycarbonates and copolycarbonates; the polycarbonates may be linear or branched by known means.

These polycarbonates are produced by known means from diphenols, carbonic acid derivatives, optionally chain terminators and optionally branching agents.

Details of the production of polycarbonates have been set down in many patent specifications over the last 40 years or so. Reference is made here by way of example only to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertne', BAYER AG, “Polycarbonates” in Encyclopedia of Polymer Science and Engineering, Volume 11, Second Edition, 1988, pages 648-718 and finally to Drs U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna, 1992, pages 117-299.

Suitable diphenols for production of the polycarbonates are for example hydroquinone, resorcinol, dihydroxydiphenyls, bis(hydroxyphenyl) alkanes, bis-(hydroxyphenyl) cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl) diisopropyl benzenes, and ring-alkylated and ring-halogenated compounds thereof.

Preferred diphenols are 4,4′-dihydroxydiphenyl, 2,2-bis-(4-hydroxyphenyl) propane, 2,4-bis-(4-hydroxyphenyl)-2-methyl butane, 1,1-bis-(4-hydroxyphenyl)-p-diisopropyl benzene, 2,2-bis-(3-methyl-4-hydroxyphenyl) propane, 2,2-bis-(3-chloro-4-hydroxyphenyl) propane, bis-(3,5-dimethyl-4-hydroxyphenyl) methane, 2,2-bis-(3,5-dimethyl-4-hydroxyphenyl) propane, bis-(3,5-dimethyl-4-hydroxyphenyl) sulfone, 2,4-bis-(3,5-dimethyl-4-hydroxyphenyl)-2-methyl butane, 1,1-bis-(3,5-dimethyl-4-hydroxyphenyl)-p-diisopropyl benzene, 2,2-bis-(3,5-dichloro-4-hydroxyphenyl) propane, 2,2-bis-(3,5-dibromo-4-hydroxyphenyl) propane and 1,1-bis-(4-hydroxyphenyl)-3,3,5-trimethyl cyclohexane.

Particularly preferred diphenols are 2,2-bis-(4-hydroxyphenyl) propane, 2,2-bis-(3,5-dimethyl-4-hydroxyphenyl) propane, 2,2-bis-(3,5-dichloro-4-hydroxyphenyl) propane, 2,2-bis-(3,5-dibromo-4-hydroxyphenyl) propane, 1,1-bis-(4-hydroxyphenyl) cyclohexane and 1,1-bis-(4-hydroxyphenyl)-3,3,5-trimethyl cyclohexane.

These and other suitable diphenols are known to the person skilled in the art, for example, and described for example in the monograph “H. Schnell, Chemistry and Physics of Polycarbonates, Interscience Publishers, New York 1964”.

In the case of homopolycarbonates only one diphenol is used, in the case of copolycarbonates several diphenols are used.

Suitable carbonic acid derivatives are for example phosgene or diphenyl carbonate.

Suitable chain terminators are both monophenols and monocarboxylic acids. Suitable monophenols are phenol itself, alkyl phenols such as cresols, p-tert.-butyl phenol, p-n-octyl phenol, p-iso-octyl phenol, p-n-nonyl phenol and p-iso-nonyl phenol, halophenols such as p-chlorophenol, 2,4-dichlorophenol, p-bromophenol and 2,4,6-tribromophenol, 2,4,6-triiodophenol, p-iodophenol, and mixtures thereof.

The preferred chain terminator is p-tert.-butyl phenol.

Suitable monocarboxylic acids are benzoic acid, alkyl benzoic acids and halobenzoic acids.

Preferred chain terminators are the phenols having formula (I) 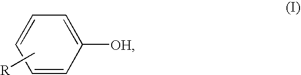
wherein
R is hydrogen, tert.-butyl or a branched or unbranched C₈ and/or C₉ alkyl radical.

The quantity of chain terminator to be used is 0.1 mol % to 5 mol %, relative to moles of diphenols used in each case. The chain terminators may be added before, during or after phosgenation.

Suitable branching agents are the trifunctional or higher than trifunctional compounds known in polycarbonate chemistry, particularly those having three or more phenolic OH groups.

Suitable branching agents are for example phloroglucinol, 4,6-dimethyl-2,4,6-tri-(4-hydroxyphenyl) heptene-2,4,6-dimethyl-2,4,6-tri-(4-hydroxyphenyl) heptane, 1,3,5-tri-(4-hydroxyphenyl) benzene, 1,1,1-tri-(4-hydroxyphenyl) ethane, tri-(4-hydroxyphenyl) phenyl methane, 2,2-bis-[4,4-bis-(4-hydroxyphenyl) cyclohexyl] propane, 2,4-bis-(4-hydroxyphenyl isopropyl) phenol, 2,6-bis-(2-hydroxy-5′-methylbenzyl)-4-methylphenol, 2-(4-hydroxyphenyl)-2-(2,4-dihydroxyphenyl) propane, hexa-(4-(4-hydroxyphenyl isopropyl) phenyl) orthoterephthalic acid ester, tetra-(4-hydroxyphenyl) methane, tetra-(4-(4-hydroxyphenyl isopropyl) phenoxy) methane and 1,4-bis-(4′,4″-dihydroxytriphenyl) methyl) benzene, as well as 2,4-dihydroxybenzoic acid, trimesic acid, cyanuric chloride and 3,3-bis-(3-methyl-4-hydroxyphenyl)-2-oxo-2,3-dihydroindole.

The quantity of branching agents optionally to be used is 0.05 mol % to 2 mol %, relative to moles of diphenols used.

The branching agents may either be included with the diphenols and chain terminators in the aqueous alkaline phase or added ahead of phosgenation dissolved in an organic solvent. In the case of the interesterification process the branching agents are added together with the diphenols.

All these measures for producing thermoplastic polycarbonates are familiar to the person skilled in the art.

In order to obtain improved compositions, it is possible for at least one other additive that is conventionally present in thermoplastics, preferably polycarbonates and copolycarbonates, to be included, such as e.g. flame retardants, fillers, foaming agents, dyes, pigments, optical brighteners, interesterification catalysts and nucleating agents or the like, preferably in quantities of up to 5 wt. % of each, preferably 0.01 to 5 wt. % relative to the total mixture, particularly preferably 0.01 wt. % to 1 wt. % relative to the amount of plastic.

The polymer compositions thus obtained may be converted by the conventional methods, such as e.g. hot press molding, spinning, extrusion or injection molding, into molded articles, such as e.g. toy components, but also fibers, films, film tapes, sheets, multi-wall sheets, vessels, pipes and other profiles. The polymer compositions may also be processed into cast films. The invention thus also concerns the use of the polymer compositions according to the invention for the production of a molded object. The use of multi-layer systems is also of interest.

Here the polymer composition according to the invention is applied in a thin layer to a molded object produced from a polymer. The application may be performed at the same time as or immediately after molding of the basic article, e.g. by coextrusion or sandwich molding. However, the application may also be made onto the finished basic molded article, e.g. by lamination with a film or by coating with a solution.

The polycarbonate molding compositions according to the invention may be processed into molded parts by for example extruding isolated polycarbonates into granules by known means and processing these granules, optionally after addition of the aforementioned additives, into various articles by injection molding by known means.

The molded parts produced from the polycarbonate molding compositions according to the invention may be used within a broad spectrum, particularly where dust accumulation is undesirable for the reasons mentioned. They are particularly suitable for use in optical data carriers, such as e.g. CDs, automotive components, such as e.g. glazing elements, plastic diffusers, also for use in extruded sheets, such as e.g. solid sheets, twin-wall sheets or multi-wall sheets, optionally also with one or more coextruded layers, and for use in injection molded parts, such as food containers, components of electrical appliances, in spectacle lenses or ornamental objects.

The polycarbonate molding compositions according to the invention may also be mixed with other conventional polymers. Particularly suitable are transparent plastics. Transparent thermoplastics are preferably used as transparent plastics, particularly preferably the polymers of ethylene unsaturated monomers and/or polycondensates of bifunctional reactive compounds.

Particularly suitable plastics for these mixtures are polyacrylates or copolyacrylates and polymethacrylates or copolymethacrylates such as e.g. polymethyl or copolymethyl methacrylate, but also especially copolymers with styrene such as e.g. transparent polystyrene acrylonitrile (SAN), also transparent cycloolefins, polycondensates or copolycondensates of terephthalic acid, such as e.g. polyethylene or copolyethylene terephthalate (PET or CoPET) or glycol-modified PET (PETG).

### EXAMPLES

Specimen Production

Sheets measuring 100×150×3.2 mm were produced by injection molding from polycarbonate (grades Makrolon 3103 and Makrolon AL 2647 polycarbonate) on a Klöckner FH160 injection molding machine. Before processing the polycarbonate granules were dried for 12 hours at 120° C. in a circulation drying oven to a residual moisture of less than 0.01%. The melt temperature was 300° C. The mold was heated to 90° C. The clamping pressure was 770 bar and the follow-up pressure 700 bar. The total cycle time for the injection molding process was 48.5 seconds.

Makrolon 3103 is a UV-stabilised bisphenol A polycarbonate with an average molecular weight M_{w} (weight average) of approx. 31,000 g/mol. Makrolon AL 2647, likewise a bisphenol A polycarbonate, contains an additive blend comprising UV stabiliser, mold release agent and heat stabiliser. Its average molecular weight M_{w} is approx. 26,500 g/mol.

The plastic automotive headlamp lenses used for testing were also made from Makrolon AL 2647. They were provided by a headlamp lens manufacturer.

The flame treatment was performed using an FTS 401 device from Arcotec, Mönsheim, Germany. The belt speed was 20 m/min, the volume of air flow 120 and the volume of gas flow 5.5 l/min. The device combination FTS 201D/9900017 was used for silicatisation.

Dust Test

In order to test the dust accumulation in a laboratory experiment, the injection molded or additionally surface-treated sheets are exposed to an atmosphere with swirling dust. To this end a 2 liter beaker with an 80 mm long magnetic stirrer having a triangular cross-section is filled to a level of approx. 1 cm with dust (carbon dust/20 g activated carbon, Riedel-de-Haen, Seelze, Germany, item no. 18 003). The dust is swirled up with the aid of a magnetic stirrer. When the stirrer is stopped the specimen is exposed to this dust atmosphere for 7 seconds. Depending on the specimen used, more or less dust settles on the specimens.

The dust accumulations (dust figures) are assessed visually. Sheets displaying dust figures were rated as minus (−), sheets virtually free from dust figures as (+).

Surface Tension

The surface tension was determined according to DIN EN 828 and the polar portion of the surface tension according to equation (8) in “Einige Aspekte der Benetzungstheorie und ihre Anwendungen auf die Untersuchung der Veränderung der Oberflächeneigenschaften von Polymeren” in Farbe und Lack, volume 77, no. 10, 1971, p. 997 ff.

Test Results:

| | | Polycarbonate | | Dust |
|---|---|---|---|---|
| Example | Specimen | grade | Surface treatment¹⁾ | test |
| 1 | 100 × 150 mm | Makrolon 3103 | None | − |
| 2 | sheet | Makrolon 3103 | 1 × flame treatment | + |
| 3 | | Makrolon 2647 | None | − |
| 4 | | Makrolon 2647 | 1 × flame treatment | +/− |
| 5 | Plastic | Makrolon 2647 | None | − |
| 6 | diffuser | Makrolon 2647 | 1 × flame treatment | +/− |
| 7 | | Makrolon 2647 | Plasma treated | + |
| 8 | | Makrolon 2647 | Corona treated | + |
| 9 | 100 × 150 mm | Makrolon 2647 | 1 × flame treatment | + |
| | sheet | | and silicated | |
| 10 | | Makrolon 2647 | 2 × flame treatment | + |
| | | | and silicated | |
| 11 | | Makrolon 2647 | 3 × flame treatment | + |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A process for the production of polycarbonate molded article having low dust attraction, comprising treating at least a portion of the surface of the article by at least one procedure selected from the group consisting of flame treatment, corona treatment and plasma treatment to obtain a treated surface.

2. The process of claim 1 wherein the treated surface displays a polar-portion of the surface tension greater than 20 percent.

3. The process of claim 1 wherein treatment is a flame treatment.

4. Process according to claim 3, characterised in that at least one compound selected from the group consisting of aluminium, tin, indium, silicon, titanium, zirconium and/or cerium compounds is added to the combustion gas/air mixture used for producing the flame to produce a metal oxide layer in the same operation.

5. The process according to claim 1 where the treatment is a continuous flame treatment at a throughput rate of 1 to 40 m/min, in particular 1 to 20 m/min.

6. The process according to claim 1 where the treatment is a continuous corona treatment at a throughput rate of 1 to 20 m/minand/or at an output of 500 to 4000 W.

7. The process according to claim 1 where the treatment is a plasma treatment at 1 to 10⁻² mbar and at an output of 200 to 4000 W in the presence of a process gas.

8. The process of claim 1 wherein the molded article is used for optical applications especially lamp covers.

9. The molded article prepared by the process of claim 1.
